(19) United States
(12) Patent Application Publication
(10) Pub. No.: US 2008/0174506 A1
(43) Pub. Date: Jul. 24, 2008

(54) DIPOLE ARRAY DIRECTIONAL ANTENNA

(75) Inventors: Jr-Ren Jeng, Taipei City (TW); Mu-Kun Hsueh, Kaohsiung City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: SmartAnt Telecom Co., Ltd., Jhudong Township (TW)

(21) Appl. No.: 12/016,148

(22) Filed: Jan. 17, 2008

(30) Foreign Application Priority Data
Jan. 19, 2007 (TW) 096201137

(51) Int. Cl. H01Q 9/16; H01Q 1/50; H01Q 19/10

(52) U.S. Cl. 343/822; 343/818

(57) ABSTRACT

A dipole array directional antenna is integrally formed. The antenna includes two radiation portions, having a signal feed-in part and a ground signal feed-in part there-between, in which the signal feed-in part receives a feed-in signal, and each radiation portion radiates a radio-frequency (RF) signal corresponding to the feed-in signal; a ground portion, formed at an area adjacent to the ground signal feed-in part, and electrically coupled to the radiation portions; and two slots, respectively opened between each radiation portion and the ground portion, for matching a line impedance of the dipole array directional antenna.

### CROSS-REFERENCE TO RELATED APPLICATIONS

This non-provisional application claims priority under 35 U.S.C. § 119(a) on Patent Application No(s). 096201137 filed in Taiwan, R.O.C. on Jan. 19, 2007, the entire contents of which are hereby incorporated by reference.

### BACKGROUND OF THE INVENTION

1. Field of Invention

The present invention relates to a dipole antenna, and more particularly to a dipole array directional antenna.

2. Related Art

With the development of wireless communication technology, various products and techniques applied for frequency multiplexing come into being. Thus, many electronic products have the function of wireless communication to meet the requirement of the consumers. Antenna is an important element in a wireless communication system for emitting and receiving electromagnetic wave energy, and dipole antennae or helical antennae are generally utilized.

Though the wireless communication may not be restricted by the landform, when an antenna is put up in an area with landform obstacles (for example, a corner of a wall or a ceiling), the gain in a particular direction is apparently insufficient, and undesirable communication effect on signal transmission and reception may occur. Therefore, a reflecting plate is usually disposed beside the antenna to enhance the antenna directivity, thereby increasing the directional gain to achieve a preferred communication effect.

At present, for some dipole antennae, a reflecting plate is locked to the body of the antenna by screws, and as the body of the antenna further includes a radiation portion and a ground portion, in which the radiation portion and ground portion also need to be interlocked by electrically insulated screws, the assembling of the dipole antenna is very complicated and time-consuming.

### SUMMARY OF THE INVENTION

In view of the above problem, the present invention is mainly directed to a dipole array directional antenna, which is integrally formed to omit an assembling process, thus enhancing the production efficiency of the dipole antenna.

The dipole array directional antenna provided by the present invention is integrally formed, and includes two radiation portions, a ground portion, and two slots.

The two radiation portions have a signal feed-in part and a ground signal feed-in part there-between, in which the signal feed-in part receives a feed-in signal, and each radiation portion radiates an RF signal corresponding to the feed-in signal. The ground portion is formed at an area adjacent to the ground signal feed-in part, and is electrically coupled to the radiation portions. The two slots are respectively opened between each radiation portion and the ground portion, for matching a line impedance of the dipole array directional antenna.

Further, a dipole array directional antenna provided by the present invention is of a printed circuit board (PCB) structure, and includes a substrate, two radiation portions, a ground portion, and two matching portions.

The two radiation portions, formed on a surface of the substrate, have a signal feed-in part and a ground signal feed-in part there-between, in which the signal feed-in part receives a feed-in signal, and each radiation portion radiates an RF signal corresponding to the feed-in signal. The ground portion is formed at an area adjacent to the ground signal feed-in part on the surface of the substrate, and is electrically coupled to the radiation portions. The two matching portions are formed between each radiation portion and the ground portion, for matching a line impedance of the dipole array directional antenna.

As for the dipole array directional antenna, the radiation portions and ground portion are integrally formed into a common loop on a metal substrate. When the dipole array directional antenna is stricken by lightning, the lightning induced charges are guided by the ground portion to the ground terminal of the wireless communication system, so as to protect the dipole array directional antenna and the wireless communication system. The length and shape of the slots may be slightly adjusted to alter the operating frequency point of the dipole array directional antenna, thus simplifying the design of the operating frequency of the antenna. Further, the antenna provided by the present invention may also be applied to PCBs, such that the weight and size of the antenna meet the design trend of being light, thin, short, and small.

### BRIEF DESCRIPTION OF THE DRAWINGS

The present invention will become more fully understood from the detailed description given herein below for illustration only, and thus are not limitative of the present invention, and wherein:

FIG. 1A is a schematic view of the appearance of a first embodiment of the present invention;

FIG. 1B is a schematic view of the appearance of a second embodiment of the present invention;

FIGS. 2A, 2B, 2C, 2D, and 2E are schematic views showing H-polarized radiation field patterns of the first embodiment of the present invention; and

FIGS. 3A, 3B, 3C, 3D, and 3E are schematic views showing V-polarized radiation field patterns of the first embodiment of the present invention.

### DETAILED DESCRIPTION OF THE INVENTION

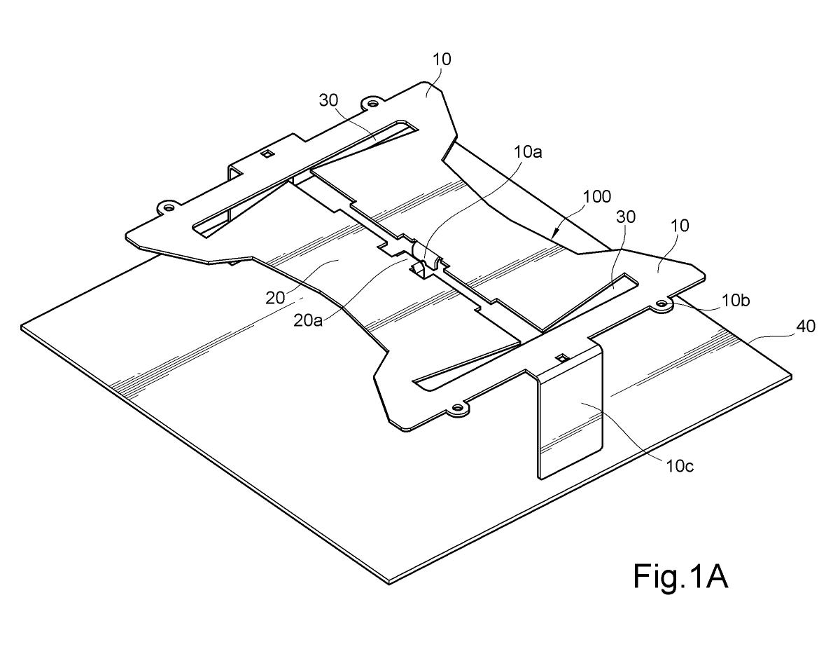

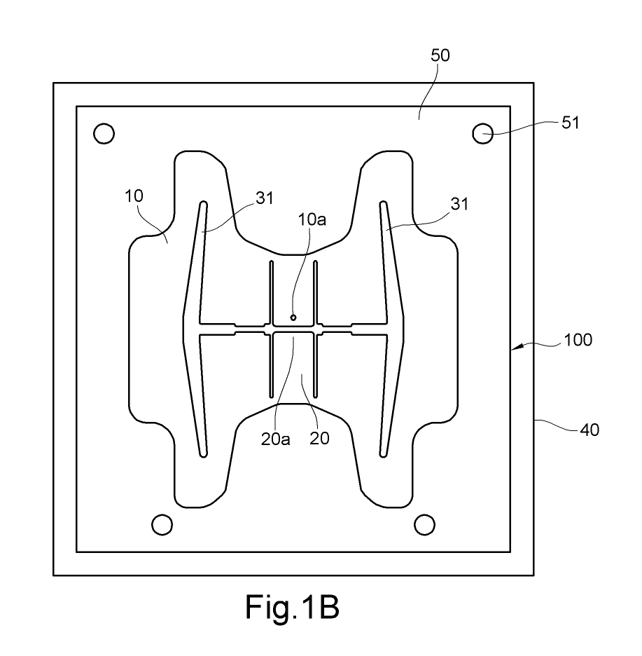

Referring to FIG. 1A, a schematic view of the appearance of a first embodiment of the present invention is shown. In FIG. 1A, a dipole array directional antenna 100 of the present invention includes two radiation portions 10, a ground portion 20, and two slots 30.

The two radiation portions 10, made of a metal conductive material (for example, copper or iron), are respectively disposed on two sides of the dipole array directional antenna 100. The two radiation portions have a signal feed-in part 10a and a ground signal feed-in part 20a there-between. The signal feed-in part 10a receives a feed-in signal, and each radiation portion 10 radiates an RF signal corresponding to the feed-in signal. The ground signal feed-in part 20a is electrically coupled to a ground terminal. Each radiation portion 10 has two fixing holes 10b and a support portion 10c made of a metal conductive material (for example, copper or iron) on one side. The fixing holes 10b are integrally formed on one side of each radiation portion 10, and are engaged with a rib (not shown) on a case (not shown) for fixing the dipole array directional antenna 100 in the case. The support portion 10c is integrally formed on one side of each radiation portion 10, and is bent into an angle of 90° from the body of the dipole array directional antenna 100, mainly for supporting the dipole array directional antenna 100 on a reflecting plate 40.

The ground portion 20, made of a metal conductive material (for example, copper or iron), is formed at an area adjacent to the ground signal feed-in part 20a, and is electrically coupled to the radiation portions 10 and a ground terminal of a wireless communication system (not shown). The ground portion 20 and the radiation portions 10 form a common loop. When the dipole array directional antenna 100 is stricken by lightning, the lightning induced charges are guided by the ground portion 20 to the ground terminal of the wireless communication system, so as to protect the dipole array directional antenna 100 and the wireless communication system.

The two slots 30 are respectively formed between each radiation portion 10 and the ground portion 20, and extend from the signal feed-in part 10a and the ground signal feed-in part 20a to the two radiation portions 10 in two substantially T-shaped structures, for matching a line impedance of the dipole array directional antenna 100. The length and shape of the slots 30 may be slightly adjusted to alter the operating frequency point of the dipole array directional antenna 100, in which each slot 30 is constituted by rectangles and triangles of different numbers and sizes. Further, the two slots 30 of the present invention form a communicated structure, and thus may be considered as one slot.

In addition, to enhance the directional gain of the dipole array directional antenna 100, the present invention adds a reflecting plate 40. The reflecting plate 40 is made of a metal conductive material (for example, copper or iron), and has an area slightly larger than that of the dipole array directional antenna 100, for reflecting the RF signal radiated by each radiation portion 10 in a particular direction. The reflecting plate 40 is spaced from the dipole array directional antenna 100 by a distance of the length of the support portion 10c. The length distance may be, for example, a full wavelength (λ), ½ wavelength (λ), or ¼ wavelength (λ) of a carrier frequency according to the design requirement. The reflecting plate 40 is further electrically coupled to the dipole array directional antenna 100 through the support portions 10c.

Referring to FIG. 1B, a schematic view of the appearance of a second embodiment of the present invention is shown. As shown in FIG. 1B, the dipole array directional antenna 100 of the present invention includes a substrate 50, two radiation portions 10, a ground portion 20, and two matching portions 31.

The substrate 50 is constituted by an substantially rectangular PCB having an upper surface and a lower surface. The substrate 50 may be of various types, such as composite substrate, ceramic substrate, metal substrate, thermoplastic substrate, and glass-fiber copper-clad substrate. A fixing hole 51 is respectively formed in four corners of the substrate 50, and is engaged with a rib (not shown) on a case (not shown), for fixing the dipole array directional antenna 100 in the case.

The two radiation portions 10, made of a metal conductive material (for example, copper or iron), are respectively formed on a surface of the substrate 50 (for example, the upper surface or the lower surface). The two radiation portions have a signal feed-in part 10a and a ground signal feed-in part 20a there-between. The signal feed-in part 10a receives a feed-in signal, and each radiation portion 10 radiates an RF signal corresponding to the feed-in signal. The ground signal feed-in part 20a is electrically coupled to a ground terminal.

The ground portion 20, made of a metal conductive material (for example, copper or iron), is formed on the same surface of the substrate 50 as the radiation portions 10, and is at an area adjacent to the ground signal feed-in part 20a. The ground portion 20 is further electrically coupled to the radiation portions 10 and a ground terminal of a wireless communication system (not shown). The ground portion 20 and the radiation portions 10 form a common loop. When the dipole array directional antenna 100 is stricken by lightning, the lightning induced charges are guided by the ground portion 20 to the ground terminal of the wireless communication system, so as to protect the dipole array directional antenna 100 and the wireless communication system.

The two matching portions 31 are respectively formed between each radiation portion 10 and the ground portion 20, and on the same surface of the substrate 50 as the radiation portions 10 and the ground portion 20. The matching portions 31 respectively extend from the signal feed-in part 10a and the ground signal feed-in part 20a to the two radiation portions 10 in two substantially H-shaped structures, for matching a line impedance of the dipole array directional antenna 100. The length and shape of the matching portions 31 may be slightly adjusted to alter the operating frequency point of the dipole array directional antenna 100, in which each matching portion 31 is constituted by rectangles and triangles of different numbers and sizes. Further, the two matching portions 31 of the present invention form a communicated structure, and thus may be considered as one matching portion.

In addition, to enhance the directional gain of the dipole array directional antenna 100, the present invention adds a reflecting plate 40. The reflecting plate 40 is made of a metal conductive material (for example, copper or iron), and has an area slightly larger than that of the dipole array directional antenna 100, for reflecting the RF signal radiated by each radiation portion 10 in a particular direction. The reflecting plate 40 is spaced from the dipole array directional antenna 100 by a distance of the length of a rib (not shown). The length distance may be, for example, a full wavelength (λ), ½ wavelength (λ), or ¼ wavelength (λ) of a carrier frequency according to the design requirement.

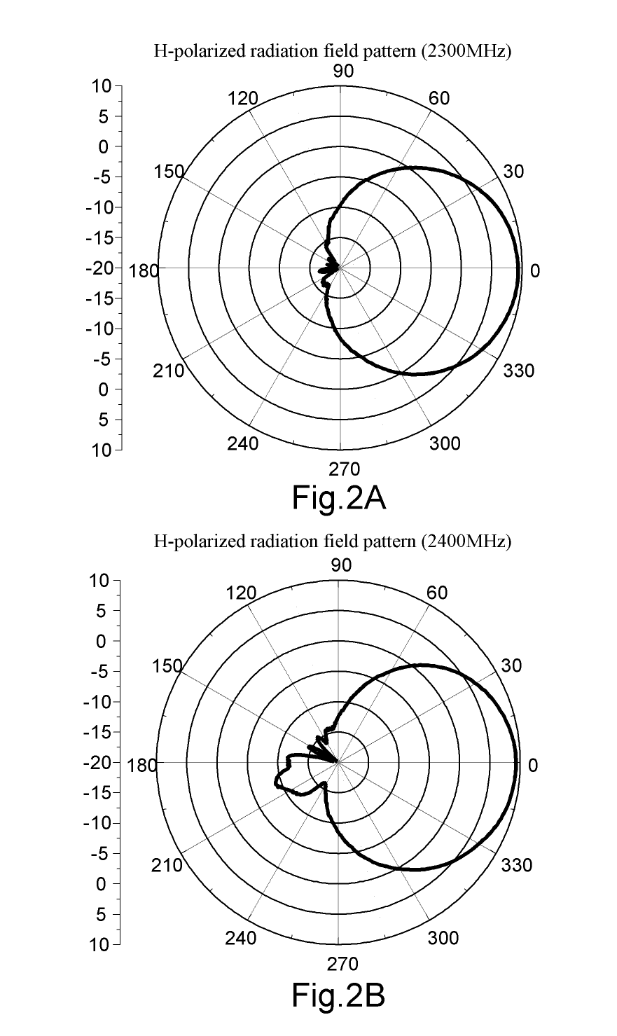

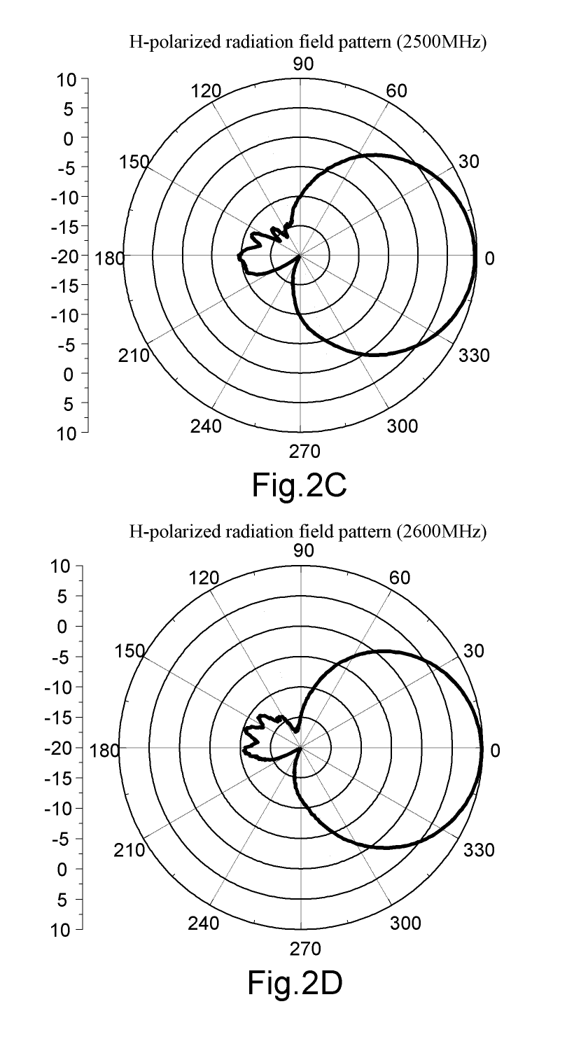

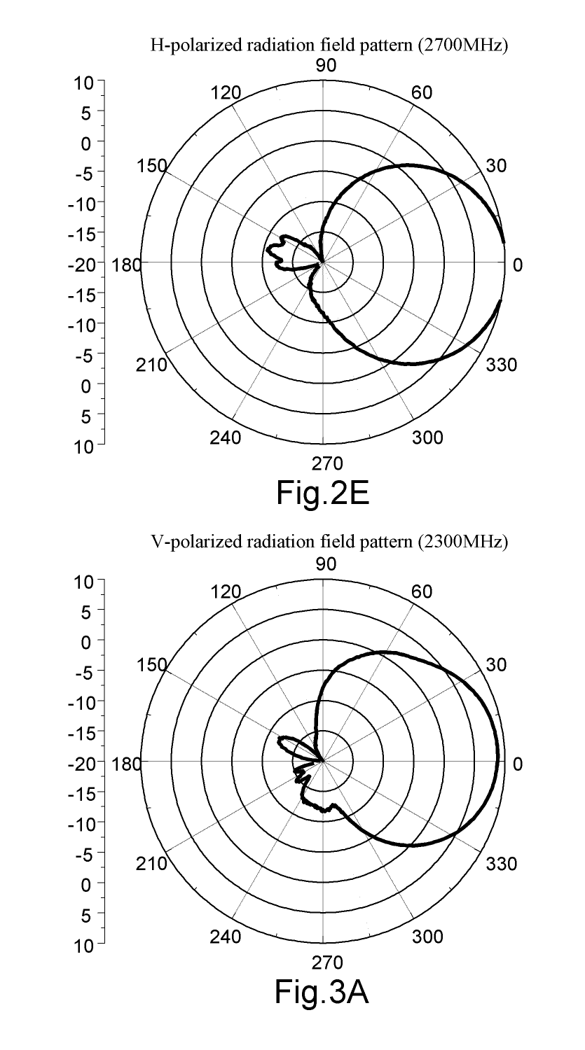

Next, referring to FIGS. 2A, 2B, 2C, 2D, and 2E, H-polarized radiation field patterns of the first embodiment of the present invention are shown, in which the operating frequency is respectively 2300 MHz, 2400 MHz, 2500 MHz, 2600 MHz, and 2700 MHz for different tests.

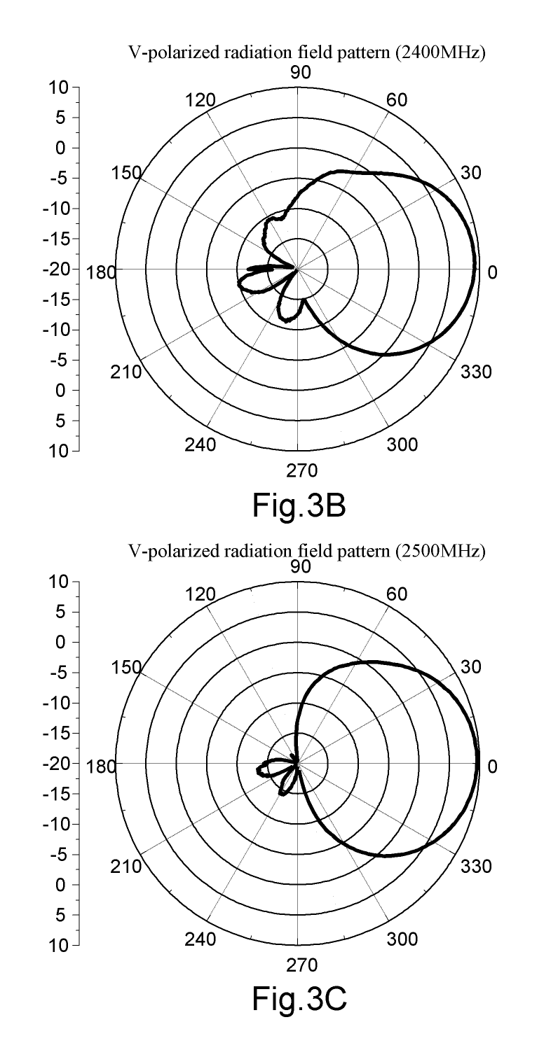

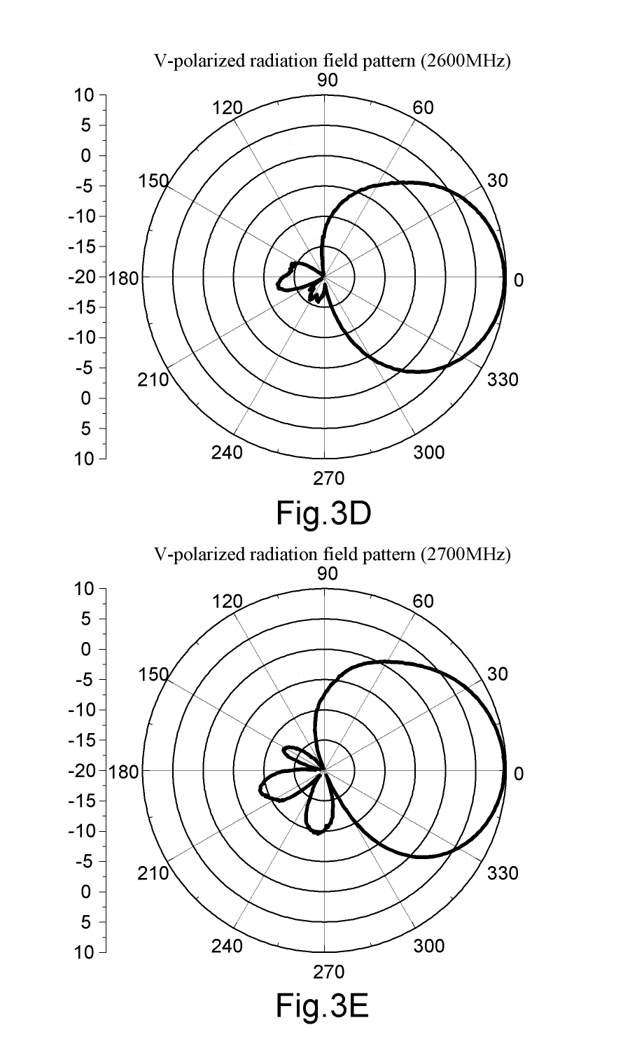

Referring to FIGS. 3A, 3B, 3C, 3D, and 3E, V-polarized radiation field patterns of the first embodiment of the present invention are shown, in which the operating frequency is respectively 2300 MHz, 2400 MHz, 2500 MHz, 2600 MHz, and 2700 MHz for different tests.

Thereafter, referring to Table 1, tests are carried out on H-polarized plane and V-polarized plane for the gain, half power beam width (HPBW), and front to back ratio at each operating frequency according to the first embodiment of the present invention.

TABLE 1

Item

| | | | | Front to Back |
|---|---|---|---|---|
| | Frequency | Gain | HPBW | Ratio |
| Plane | (MHz) | (dBi) | (°) | (dB) |
| H-polarized | 2300 | 9.33 | 64 | 29.4 |
| | 2400 | 9.30 | 63 | 20.9 |
| | 2500 | 9.64 | 61 | 19.1 |
| | 2600 | 9.81 | 59 | 20.6 |
| | 2700 | 10.29 | 58 | 22.6 |
| V-polarized | 2300 | 8.82 | 59 | 31.9 |
| | 2400 | 9.17 | 55 | 21.0 |
| | 2500 | 9.55 | 60 | 23.9 |
| | 2600 | 9.69 | 57 | 22.8 |
| | 2700 | 9.7 | 58 | 24.0 |

In view of the above, as for the dipole array directional antenna of the present invention, the radiation portions and ground portion are integrally formed into a common loop on the same metal substrate. When the dipole array directional antenna is stricken by lightning, the lightning induced charges are guided by the ground portion to the ground terminal of the wireless communication system, so as to protect the dipole array directional antenna and the wireless communication system. The length and shape of the slots may be slightly adjusted to alter the operating frequency point of the dipole array directional antenna, thus simplifying the design of the operating frequency of the antenna.

What is claimed is:

1. A dipole array directional antenna, comprising:
two radiation portions, having a signal feed-in part and a ground signal feed-in part there-between, wherein the signal feed-in part receives a feed-in signal, and each radiation portion radiates a radio-frequency (RF) signal corresponding to the feed-in signal;
a ground portion, formed at an area adjacent to the ground signal feed-in part, and electrically coupled to the radiation portions; and
two slots, respectively opened between each radiation portion and the ground portion, for matching a line impedance of the dipole array directional antenna.

2. The dipole array directional antenna as claimed in claim 1, wherein each slot is substantially T-shaped.

3. The dipole array directional antenna as claimed in claim 1, further comprising a reflecting plate, for reflecting the RF signal radiated by each radiation portion in a particular direction.

4. The dipole array directional antenna as claimed in claim 3, wherein each radiation portion has a support portion on one side, for supporting the dipole array directional antenna on the reflecting plate.

5. The dipole array directional antenna as claimed in claim 4, wherein the reflecting plate is spaced from the dipole array directional antenna by a distance of a length of the support portion.

6. The dipole array directional antenna as claimed in claim 1, wherein each radiation portion further has at least one fixing hole, for fixing the dipole array directional antenna in a case.

7. The dipole array directional antenna as claimed in claim 1, wherein the dipole array directional antenna is integrally formed.

8. A dipole array directional antenna, comprising:
a substrate;
two radiation portions, formed on a surface of the substrate, having a signal feed-in part and a ground signal feed-in part there-between, wherein the signal feed-in part receives a feed-in signal, and each radiation portion radiates an RF signal corresponding to the feed-in signal;
a ground portion, formed at an area adjacent to the ground signal feed-in part on the surface of the substrate, and electrically coupled to the radiation portions; and
two matching portions, formed between each radiation portion and the ground portion, for matching a line impedance of the dipole array directional antenna.

9. The dipole array directional antenna as claimed in claim 8, wherein each matching portion is substantially H-shaped.

10. The dipole array directional antenna as claimed in claim 8, further comprising a reflecting plate, for reflecting the RF signal radiated by each radiation portion in a particular direction.
